(19) United States
(12) Patent Application Publication
(10) Pub. No.: US 2005/0039987 A1
(43) Pub. Date: Feb. 24, 2005

(54) Elevator landing and control apparatus and method

(76) Inventor: Ray Redden, Sacramento, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/674,092

(22) Filed: Sep. 29, 2003

Related U.S. Application Data
(60) Provisional application No. 60/415,237, filed on Sep. 30, 2002.

(51) Int. Cl. B66B 1/34; B66B 3/00

(52) U.S. Cl. 187/394

(57) ABSTRACT

The present invention relates to elevator landing control apparatus and methodology used, for example, to sense an elevator car's position and to identify floors, that are simple to install, cost effective, highly reliable, and safe and effective.

Pursuant to 37 C.F.R. §1.78(a)(4) and 35 U.S.C. §119(e), this application claims the benefit of U.S. Provisional Application Ser. No. 60/415,237, filed Sep. 30, 2002.

### BACKGROUND OF THE INVENTION

1. Field of the Invention

This invention relates generally to motion sensing and control devices, and more particularly to novel elevator positioning and control apparatus and methods.

2. Discussion of the Related Art

Safe, efficient operation and control of elevators requires accurately measuring or sensing a number of factors. Methods and apparatus that are used to acquire necessary signals vary. However, virtually all elevator car position systems must provide at least the following information, in one form or another.

“Direction up” is an increase of an elevator car's height within the hoistway or elevator shaft, and “direction down” is a decrease of the car's height within the hoistway.

“Speed” (velocity) is the required time for the car to move a specified distance.

“Position” is a specific height of the car within the hoistway.

“Landing zone” is a distance above and below an intended floor that the car's position sensing system first acquires a floor specific signal. This distance is typically within one foot of the floor.

“Door zone” is distance above and below an intended floor that the car's position sensing system acquires floor specific door control signals. When approaching a floor, door zone signals are sensed at a position from the floor that is safe to begin a door opening operation. This distance is typically ±3.0 inches of the floor.

“Floor level” or “floor zone” is a differential between the elevator car's position and the building floor that will not place a person exiting or entering an elevator car at risk of tripping. This distance is typically ±⅛ inch.

“Floor number” is a discreet floor identity code sensed by the controller. This code enables the controller to identify a car's position within the hoistway in relation to each other.

All seven of the aforementioned factors preferably should be attained in one form or another for safe elevator operation. “Hard” factors (i.e., actual signals) may be obtained. It is also possible to derive some of the factors based upon other factors or signals (or upon combinations thereof). However, hard or non-derived signals will generally provide maximum safe elevator operation.

Traditional elevator positions systems have measured some or all of these factors through the use of a follower wire that is wrapped around a drum to rotate the drum as the elevator car travels higher or lower. The drum's rotation is sensed by various methods.

Chains and tape have also been used in a manner similar to the wire. For example, linear tape can be mounted between the top and the bottom of the hoistway. The linear tape can be perforated for optical sensing, or magnets may be installed on the surface of the tape for reed switch sensing.

Encoder signals have also been used. For example, encoding follower wheels may connected to a tire, which is installed on the face of an elevator rail. The encoder will provide quadrature pulses that will enable the electronics sensing to count up or down for car position.

Hall Effect sensors have also been used in connection with elevator car sensing. As is known in the art, Hall Effect sensors are devices which sense a voltage created by the Hall Effect. The Hall Effect provides that when a conductor carrying a current is placed in a magnetic field, a voltage potential is generated perpendicular to the direction of both the magnetic field and the current carried in the conductor. Commercially available Hall Effect sensors sense this voltage potential created by the magnetic current, called the Hall Effect voltage, and are able to pass that voltage on to other circuitry. Prior art approaches have mounted magnets on a tape, bracket, or similar device that is used for measuring floor zone and/or door zone.

Other traditional floor encoding systems utilize optical veins, magnet combinations and the like.

All of the aforementioned approaches are mechanically complex, expensive to manufacture and maintain, and have reliability problems because of their complexity. Some of the approaches are difficult to install and to calibrate because complex brackets and targets are required. In addition, industry safety requirements are ever specifying better signal sources for safe system operation.

### SUMMARY OF THE INVENTION

The present invention relates to elevator landing control apparatus and methodology used, for example, to precisely sense an elevator car's position and to identify floors, that are simple to install, cost effective, highly reliable, safe and effective. The present invention comprises the use of one or more targets (e.g., a magnet) mounted, for example, in the pocket of an elevator T-rail, and one or more sensors that are adapted to sense a signal generated by the target. The novel mounting of the target within the T-rail eliminates the need for brackets, tape or other apparatus heretofore needed for elevator control, greatly reducing installation and maintenance costs. The present invention also includes novel usages of radio frequency identification (RFID) to precisely sense signals and control the elevator system function.

### BRIEF DESCRIPTION OF THE DRAWINGS

FIG. 1 is a top view of an embodiment of the present invention showing a direction sensor and speed sensor apparatus of the present invention.

FIG. 2 is a top view of an embodiment of the present invention showing a direction sensor, speed sensor, landing zone sensor and door zone sensor apparatus of the present invention.

FIG. 3 is a front, elevational view of an embodiment of the present invention showing an elevator hoist way T-rail with apparatus for sensing door zone and landing zone.

FIG. 4 is a front, elevational view an embodiment of the present invention showing an elevator hoistway rail with apparatus used for simultaneous operation of a front door and a rear door of an elevator car.

FIG. 5 is a top view of an embodiment of the present invention showing a direction sensor and speed sensor, a landing zone sensor and a door zone sensor, and a floor number transponder reader.

FIG. 6 is a sectional view of an embodiment of the present invention showing an elevator T-rail showing apparatus for sensing door zone and landing zone.

### DETAILED DESCRIPTION OF THE PREFERRED EMBODIMENTS

The present invention includes novel apparatus and methods for sensing the aforementioned positioning and floor identification factors, namely: direction, speed, position, landing zone, door zone, floor level and floor number. To sense some of the aforementioned factors (e.g., landing zone, door zone, floor level, floor number), at least one target (e.g., a magnet) is mounted within a pocket of a T-rail within the elevator hoist way, and a sensor mounted on the elevator car is used to generate a control signal based on said position of said sensor relative to the position of said target. The operation of the elevator car (e.g., speed, direction, door opening or closing, floor selection, etc.) can then be controlled by a microprocessor based upon the control signals.

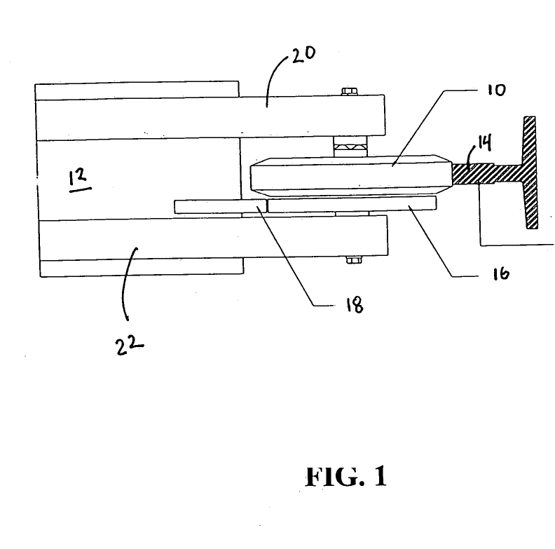

Referring to FIG. 1-FIG. 3, in a preferred embodiment of the present invention, to sense an elevator car's direction, speed and/or position, a wheel and tire assembly 10 is mounted on the top of the car 12 in such a way that the wheel's tire rides on the face of the rail 14. In addition, a magnetically encoded ring 16 is installed on the side of the wheel. Significantly, existing elevator wheel assemblies can be easily adapted for use in connection with the present invention. A dual element Hall Effect sensor 18 is then positioned in proximity to the ring 16 which senses the magnetic poles. A signal is generated by the movement of the ring 16 relating to the sensors 18. The control signal corresponds to the car's speed, direction and/or position.

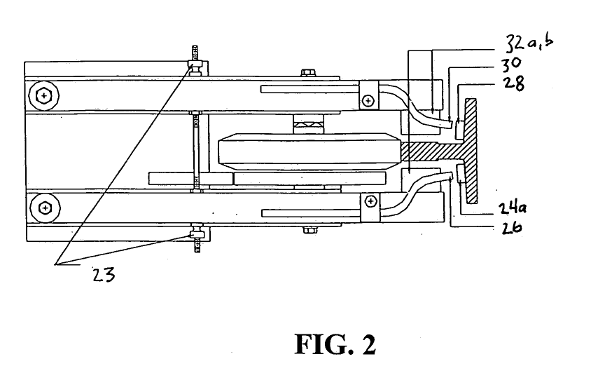

In a preferred embodiment, first and second arms 20, 22 are also provided to mount the wheel and tire assembly. The arms move laterally (i.e., back and forth) to maintain constant pressure of the wheel against the face of the rail during operation. A guide block clearance adjustment device 23 (shown in FIG. 2 as an adjustable, threaded member) is also provided for adjusting the clearance of the guide blocks (discussed more below).

In a preferred embodiment, the magnet poles of the magnetically encoded ring 16 provide one hundred magnetic pole pairs per revolution of the wheel. This number of poles is equal to sixty-four quadrature signal sets per foot of car travel. The spacing of the encoded poles can be optimized for the spacing of the sensing elements' displacement with, for example, the Allegro 2425 Dual, Chopper-Stabilized Effect Sensor. The Allegro 2425, when used with the encoder ring 16, has been found to provide optimal quadrature signals. Each quadrature set provides four position data signals. Therefore, a controller processor (not shown) can receive a car position quadrature signal update for each 0.05 inches of car travel. These signals are then decoded and integrated by the control processor by known methods to determine the car's direction, speed and position.

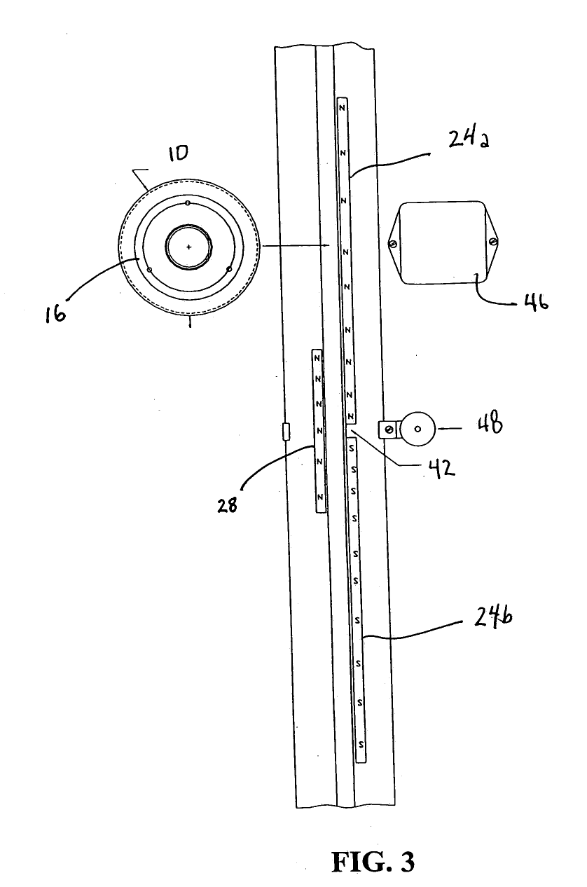

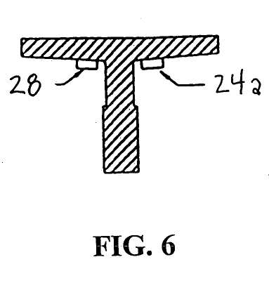

Referring to FIG. 2, FIG. 3, and FIG. 6, to sense car landing zone a plurality of magnets (e.g., 24a, 24b) are attached along sides of the rail 14 within the pocket of the rail 14, and a Hall Effect voltage is sensed by landing zone Hall Effect sensor 26. Similarly, to sense door zone a plurality of magnets 28 are attached along the sides of the rail 14, and a Hall Effect voltage is sensed by a door zone Hall Effect sensor 30. In a preferred embodiment, the magnets are centered or positioned at a constant depth (i.e., within a tolerance of 0.003 inch to 0.005 inch) within the T-rail for precise control signals.

Adjustable guide blocks 32a,b keep the Hall Effect sensors 26, 30 aligned with their respective magnets (e.g., 24a,b, 28), regardless of the side-to-side car movement. As shown in FIG. 2, the sensors, 26, 30 are adapted to reach into the “T” pocket of the rail 14 where the magnets are installed.

Referring to FIG. 3, in a preferred embodiment there are two landing zone magnets 24a,b per floor. In a preferred embodiment, each magnet is 12″ long. The upper magnet 24a is placed against the rail with its North pole away from the rail and towards the sensor. The lower magnet 24b is placed against the rail with its North pole against the rails and its South pole toward the sensor. The range of the landing zone can be determined by the total length of the two landing zone magnets, and may be increased or decreased by selection and spacing of appropriate magnets. The Hall Effect sensor 26 has the ability to differentiate between the North and South pole magnetic signals. Therefore, the controller can use the sensor signal to control the movement of the car up or down toward the car level-at-the-floor position. As shown in FIG. 3, in the preferred embodiment the landing zone magnets are installed on the right side of the rail “T”.

Referring again to FIG. 3, the door operation location is determined by the position of the door zone magnet 28. The center of the door zone 28 magnet position is preferably correlated with the junction of the landing zone magnets. As shown in FIG. 3, in the preferred embodiment the door zone magnet is installed on the left side of the rail “T”. The door can be safely opened within the door zone magnet range. For example, when the car is within 3″ of the floor level position, the Hall Effect sensor located on the left side of the rail will signal the controller that “door zone” position has been attained.

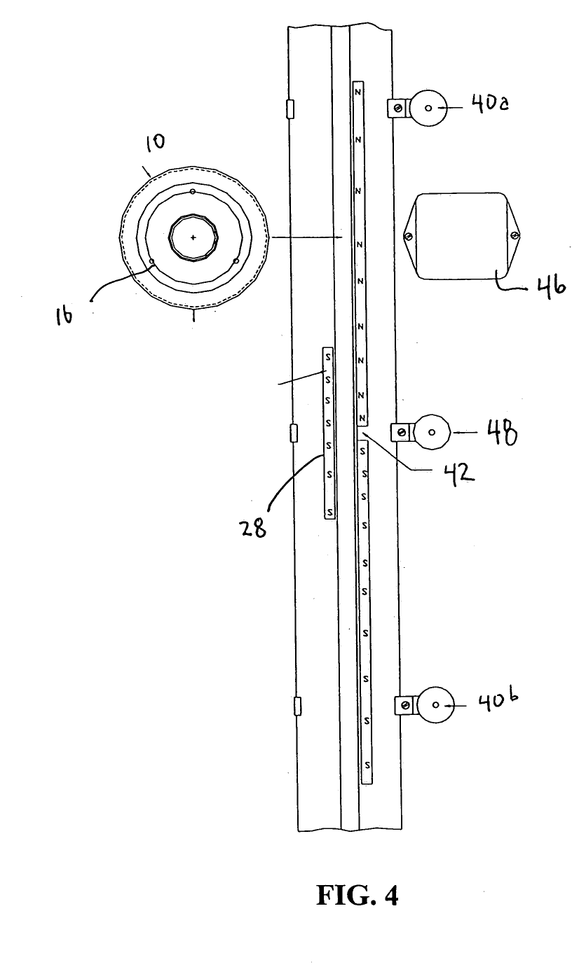

Referring to FIG. 4, when the car is within the landing zone, and if both the front door and rear door are to be opened, dual door transponders 40a,b are installed. When the elevator car is inside of the landing zone, transponders 40a,b will cause a flag to be set within the interface board. When the car is within door zone, the interface electronics will signal the controller that door zone position has been attained and that both a front door and a rear door exists. The front/rear door flag is reset when the car leaves the landing zone. Front door and rear door can also be opened separately. If the door zone magnet 28 is installed with its North pole away from the rail, the controller is informed that a front opening exists at the landing. Conversely, if the door zone magnet's South pole is away from the rail, the controller is informed that a rear opening exists at the landing.

Also, the transponder reader has the ability to recognize a special control responder which is used for the operation of the front and real doors that are located on the same floor. The reader provides a dedicated control signal wire for this function.

Referring to FIG. 4, determining when the car is level with the floor is attained by sensing when the landing zone Hall effect sensor is between the North pole and the South pole landing zone magnets and the door zone magnet is sensed by the door zone sensor. The gap 42 between the North pole and South pole landing zone magnets will determine the amount of the car's level “dead zone” or hysterisis that the controller will have when positioning the car's threshold level with the floor. When an ideal magnet separation space is attained (i.e., by adjusting the floor level zone) and the landing zone magnets are installed symmetrically above and below the floor, the car will level within ⅛″ of the floor.

The floor level zone's edge can be determined with the elevator car going up and/or going down. A processor (not shown) is utilized to determine a car level-with-the-floor height that can be adjusted within the level zone through software. This enables greater tolerance in positioning the magnets or sensors, and for the processor to be used for final floor level fine tuning. The magnets or sensors are positioned to provide a wide level zone and the processor learns the precise car level-with-the-floor point.

Once the optimum space between the landing zone magnets is determined for best level zone performance, all of the landing zone magnets for each floor can be installed with the same spacing.

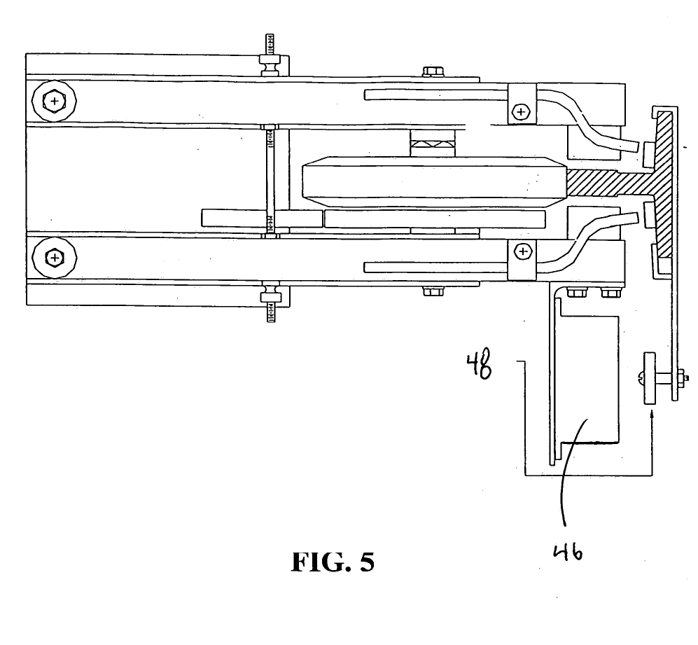

Referring to FIG. 4 and FIG. 5, floor number is also sensed. In addition to the Hall Effect sensors, a transponder reader 46 is attached to the encoder/sensor carrier. Additionally, a floor number transponder 48 is attached to the rail at each floor. The transponder 46 is installed at the car's approximate floor level position.

When a transponder reader 46 is within 3″ of the transponder 48, the reader senses a unique forty-two bit binary number from the transponder. The reader then translates the forty-two bit number into the appropriate binary floor number.

A uniquely coded transponder is located at each floor. When the car is near a floor the controller is provided with a known floor number value. This value is continuously sent to the controller as long as the car is within door zone.

After the system has been installed, a “learn” signal is received by the interface board when the controller is learning the hoistway. The transponder reader receives the floor number transponder signals and assigns floor numbers in sequence. Once learned, the reader will translate the transponder signals and send the floor number to the controller whenever the reader is in proximity with the transponder. In the event that a transponder is lost or damaged, it can be replaced. The reader will learn the replacement transponder's code by positioning the elevator car at the floor below the newly installed transponder. When a “learn next” control signal is invoked, the car is moved to the next floor, the reader will then substitute the new transponder's code in place of the old transponder's code.

The use of radio frequency identification (RFID) to determine floor number or to instruct the processor to perform a special operation such as front door and back door operation provides substantial benefits. Transponder tags may be utilized to create numerous controller signals and instructions for elevator operation and control.

In addition to the parallel floor number signal provided by the reader, the reader can output a serial floor number value. For example, the serialized floor number may be provided in RS-232 format at TTL levels. By mounting a radio frequency identification (RFID) reader on the car top and a transponder at each floor, the controller knows which floor position it has reached. The RFID system has the ability to translate any transponder (tag) number to the correct floor car position, which provides a substantial advantage in the event of a power failure recovery. Also, this information provides a higher level of safety in the elevator operation. The RFID tag is a small button that is easily mounted.

The Hall Effect sensors' signals are fed to an interface/signal drive board (not shown). Each signal is optimized for the programmable logic device (PLD) which is resident on the signal conditioning board. After optimization, all signals are then sent to the controller at the voltage levels required by the controller.

In addition to the Hall Effect sensors, the signal conditioning board receives binary floor number signals from the transponder reader.

In addition, the Transponder reader has nearly the same sensitivity to a transponder as the door zone range (±3″). The transponder reader signal may provide an alternative-to the door zone magnet or function as a door zone confirmation back up.

By using the rail as the sensor signal mounting base, all of the brackets have been eliminated. Also, every sensor is positioned by a single car-top mounted carrier. The expensive encoder has been eliminated.

Simple low cost installation aids can be designed that will enable the magnets to be positioned with ease and accuracy. The car position system will turn-on and run with very little additional calibration or adjustment.

The interface board's PLD allows for future flexibility of signal configurations that were not possible with LS QUIK or LS QUAD.

In the present invention, all signals are sensed with precision. Because of this precision, the present invention can be adapted by know methods to use implied signals in place of some hard signals.

It is to be understood that the description of the present invention and the embodiments stated herein are not to be interpreted as limiting the scope of the invention in any way. It is apparent to those skilled in the relevant arts that many modifications and adaptations of the invention described herein can be made without departing from the scope of the invention as defined by the claims herein. For example, because of the sensor centering and depth control capabilities (i.e., placing the face of the wheel against the rail controls the depth of the sensor) numerous combinations of sensors and magnet strips can be used to obtain precise signals.

1. An elevator car positioning and control apparatus for use within an elevator hoist way having a rail mounted within the hoist way, comprising:
(a) a first target mounted to the elevator car;
(b) a second target mounted at a predetermined position within a pocket of said rail;
(c) at least one sensor mounted to the elevator car; and
(d) wherein said sensor senses said first target and generates a first control signal corresponding to at least one of the elevator car's direction, speed or position, and senses said second target and generates a second control signal corresponding to at least one of the elevator car's landing zone, door zone, floor level or floor number.

2. An elevator car positioning and control apparatus for use within an elevator hoist way having a rail mounted within the hoist way, comprising:
(a) a target mounted within a pocket of said rail;
(b) at least one sensor mounted on the elevator car; and
(c) wherein said sensor senses said target and generates a control signal corresponding to at least one of the elevator car's landing zone, door zone, floor level or floor number.

3. An elevator car positioning and control apparatus for use within an elevator hoist way, comprising:
(a) mounting a radio frequency identification reader to the elevator car;
(b) mounting at least one transponder at a predetermined position corresponding to a position of a floor within the elevator; and
(c) using said reader to sense said transponder and generate a signal based upon the position of said reader relative to said transponder.

4. A method for controlling the operation of an elevator car within an elevator hoist way, the hoist way having a rail mounted therein, the method comprising the steps of sensing at least one of an elevator car's direction, speed, position, landing zone, door zone, floor level and floor number within an elevator hoist way, the method comprising:
(a) positioning a first target on the elevator car;
(b) positioning a second target within a pocket of a first and second said rail;
(c) mounting at least one sensor on the elevator car; and
(d) generating a plurality of control signals corresponding to at least one of the elevator car's speed, direction, position, floor zone, door zone, floor level, and floor number, based on the position of the sensor relative to said first and second targets; and
(e) using a, microprocessor to control the operation of said car based upon said control signals.
